(19) United States
(12) Patent Application Publication
(10) Pub. No.: US 2012/0147694 A1
(43) Pub. Date: Jun. 14, 2012

(54) MIXER FOR A BEVERAGE FILLING PLANT

(75) Inventor: Erwin Engel, Donaustauf (DE)

(73) Assignee: KRONES AG, Neutraubling (DE)

(21) Appl. No.: 13/314,322

(22) Filed: Dec. 8, 2011

(30) Foreign Application Priority Data
Dec. 10, 2010 (DE) 10 2010 062 798.4

(51) Int. Cl. B01F 3/04; B01F 15/06; A23L 2/54; B01F 15/02

(52) U.S. Cl. 366/144; 366/160.3; 261/150

(57) ABSTRACT

A mixer for mixing and conveying different fluids for a beverage filling plant, with at least one first container section for receiving a first starting fluid, with a second container section for receiving a second starting fluid. A first pump is disposed in a first conduit leading out of the first container section for supplying the first starting fluid to a mixing area, and a second pump is disposed in a second conduit leading out of the second container section for supplying the second starting fluid to the mixing area. The first pump and the second pump are driven by one synchronous motor each and each synchronous motor is connected to a frequency converter, and the first and the second container sections are in one common container. Also, a beverage filling plant with such a mixer and a method of operating such a beverage filling plant are disclosed.

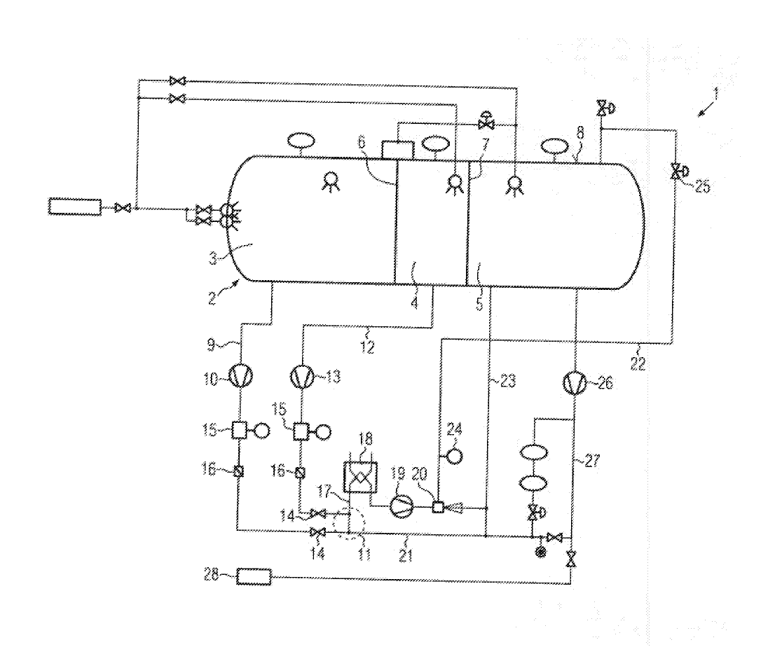

### CROSS-REFERENCE TO RELATED APPLICATION

The present application claims the benefit of priority of German Application No. 102010062798.4, filed Dec. 10, 2010. The entire text of the priority application is incorporated herein by reference in its entirety.

### FIELD OF THE DISCLOSURE

The disclosure relates to a mixer for mixing and conveying different fluids for a beverage filling plant with at least one first container section for receiving a first starting fluid, with a second container section for receiving a second starting fluid.

### BACKGROUND

Mixers of this type include a first pump disposed in a first conduit leading out of the first container section for supplying the first starting fluid to a mixing area, and a second pump disposed in a second conduit leading out of the second container section for supplying the second starting fluid to the mixing area.

Such mixers are well-known from prior art and are employed in beverage filling plants. In such mixers, a first starting fluid, such as water, is mixed with a second starting fluid, such as a syrup. Furthermore, the mixer supplies, at a site contained in the mixing area or disposed downstream of the mixing area, an impregnation medium to the pre-mix produced from the two liquids. The pre-mix, which is a mixture of water and syrup, is then mixed with gas. The mixture mixed with gas is then intermediately stored in a separate container to be filled into packs, such as bottles, at a filler.

Such mixers are known, for example, from DE 43 15 234 C2. There, a method and a device for producing liquid mixtures of different individual components are disclosed. The method disclosed in this citation relates to the feeding of individual components or partial amounts of them in one or several intermediate stages of a multistage centrifugal pump.

Another citation, that is DE 35 01 127 C2, relates to a device for producing mixed drinks from at least two liquid components, one of which is water. The two components are supplied to a mixing chamber with the assistance of one electrically driven pump for each component. The subject matter in this citation is characterized in that the pump for the water forming the one component is a centrifugal pump with a separate drive, that a control unit is provided to which an actual value signal is supplied that corresponds to the amount of water supplied to the mixing chamber, and to which a further actual value signal is supplied that corresponds to the speed of the electric motor for the pump delivering the second component, and that the control unit generates a set value signal by means of which the voltage and/or the power for the electric motor which drives the pump delivering the second component can be controlled.

Up to now, however, asynchronous motors to drive the corresponding pumps have been always used, wherein the control of the amount of the first and/or second starting fluid is achieved by throttles disposed downstream. These throttles, however, have a disadvantage in that they cause flow resistances that affect hydraulic efficiency. In existing plants, the liquid components involved are moreover each stored in separate containers, whereby several different containers must be used, having a substantial negative effect on the production price of the mixer.

Furthermore, it has been common up to now to dose the individual components, that is e.g. the first and the second starting fluids, using a control valve and increased pressure. The increased pressure at which the liquid components are maintained requires a high amount of electrical power which is assessed as being negative. Moreover, the operation mode of the employed pumps in the so-called throttle operation counteracts a high hydraulic efficiency of the pumps. It furthermore shows in prior art that the drives of the pumps often have very unfavorable energy efficiencies due to their “indistinct” design and as a result of the sometimes extended operation range.

It is one aspect of the present disclosure to avoid the disadvantages of prior art and to provide a mixer which can be manufactured at considerably lower costs and simultaneously comprises optimized energy efficiency. Expensive control valves that are disposed downstream are to be avoided.

According to the disclosure, this aspect occurs due to the first pump and the second pump being driven by one synchronous motor each, and each synchronous motor is connected to a frequency converter for flow control, the first and the second container sections being embodied in one common container.

In this manner, the number of containers involved is considerably reduced as only one common container is now required for the different starting fluids. Moreover, by using the frequency converter, one can act on the synchronous motors such that the first pump and the second pump withdraw more or less liquid, that means more or less mass of the first starting fluid and more or less mass of the second starting fluid, from the common container, corresponding to the excitation of the frequency converter.

Pressure reduction in a throttle is thus eliminated, whereby the first and second starting fluids can be stored in the common container already at a minimized pressure. This is because pressure reduction in a throttle disposed downstream does not occur. Instead of asynchronous motors that have been common up to now, by the use of synchronous motors on the drive side, maximum efficiency is achieved. Due to the flow control by modulating the speed of the respective centrifugal pump, one can do without positive-displacement pumps or control valves. It is also possible to actuate the respectively required operating point, with respect to the flow rate, in a defined manner in adapting the speed of the respective centrifugal pump. This results in a more energy efficient embodiment of the mixer.

Product guidance, that means the guidance of the starting fluids and the mixture of the two starting fluids with or without impregnation medium, becomes possible near the saturated vapor pressure reached due to physical conditions, which in turn results in a more energy efficient design of the mixer and also helps to avoid gas losses after the introduction of an impregnation medium, for example in a head room of a container holding the finished mixture.

If in case of sensitive products, product guidance even above the saturated vapor pressure reached due to physical conditions is necessary, this is also possible, where metered addition is achieved using an optional control valve to which the required opening degree is allocated on the basis of a measured differential pressure. This is referred to as Kᵥ value control. The loss of impregnation gas in the last collecting vessel is minimized.

It is, for example, advantageous for the first pump and the second pump to be each designed as centrifugal pumps. Such centrifugal pumps can be particularly well controlled and also have a very high efficiency at simultaneously low costs.

If in the mixing area after an opening area of the second conduits into the first conduit, a cooler is arranged, where furthermore a mixture pump for delivering the cooled mixture of the first and the second starting fluids to an injector downstream of the first and the second pump is arranged, the mixture of liquid obtained from the first starting fluid and the second starting fluid can on the one hand be correspondingly cooled and supplied to an injector at a speed optimized for the injector with respect to the feed speed.

It is furthermore advantageous for an injector outlet area to be connected with a third container section of the container, for example via a conduit, to intermediately store the fluid prepared for filling at the beverage filling plant. By this, the processability of the finished mixture is improved, and a buffer capacity in case the filler fails is realized. Since additional media must often be supplied to the mixture of the first starting fluid and the second starting fluid, it is advantageous for the injector to be designed for supplying an impregnation medium, such as gas.

It is then furthermore advantageous for the first starting fluid to be a liquid, such as water, the second starting fluid to be a liquid, such as syrup, and the impregnation medium to be CO₂, O₂, nitrogen, air or nitrous oxide and a mixture of these ingredients. In this manner, numerous beverages which have gained acceptance on the market can be produced.

If a bypass conduit arranged downstream of the injector ensures a circuit from the opening area via the cooler, the mixture pump driven by a synchronous motor, the injector to the opening area, or vice-versa, the mixture can be supplied at a speed optimized with respect to the injector, where simultaneously the mixing ratio of the starting fluids and their quantities are variable. Moreover, with a constant mixture speed at the injector, a variable working speed can be selected. Furthermore, different amounts of first and/or second starting fluid can here be supplied to the cooler and/or to the mixture pump. By using the bypass conduit for obtaining a circuit, the homogeneity of the obtained final mixture can also be increased.

If a product pump driven by a synchronous motor is disposed downstream of the third container section, one can here also dispense with special throttles, and with a corresponding control of the synchronous motor by the product pump, which is preferably designed as a centrifugal pump, a selective quantity of finished mixture can be withdrawn from the container comprising three chambers.

Hydraulic efficiency can be increased if no separate throttle is installed in the mixer.

The disclosure also relates to a beverage filling plant which is, according to the disclosure, characterized in that it comprises a mixer as explained above.

Mechanical seals, for example close to the motor, can be avoided if a motor with a direct drive or a gearless motor, such as a torque motor, is employed as the synchronous motor for one of the pumps.

Moreover, the disclosure relates to a method of operating a beverage filling plant containing a mixer as explained above.

Such a method is characterized in that the frequency converter of the respective synchronous motor of the first pump, the second pump, the mixture pump and/or the product pump is controlled such that flow control is achieved via the modulation of the respective pump.

The efficiency of the method is improved if the flow of mixed liquid at the injector is kept constant while the working speed of the individual components is kept variable. The supply of impregnation media can then be optimized with respect to the flow rate of the injector. In particular if the injector is designed as a venturi tube, the gas can be supplied at a speed optimized for the venturi tube, wherein the amount of liquid mixture flowing through the injector, consisting of the first starting fluid and the second starting fluid, is also adapted to the venturi tube with respect to its feed rate.

### BRIEF DESCRIPTION OF THE DRAWING

The disclosure will be illustrated below more in detail with reference to a drawing where:

The figure shows a mixer for a beverage filling plant in a first embodiment, and is only a schematic and only serves the understanding of the disclosure.

### DETAILED DESCRIPTION OF THE PREFERRED EMBODIMENT

The figure shows a mixer 1. The mixer comprises a container 2. The container 2 is divided into different container sections 3, 4 and 5. The first container section 3 is at least partially filled with a first starting fluid, such as a liquid, for example water. The first container section 3 is separated from a second container section 4 in a fluid-tight manner. The second container section 4 at least partially contains a second starting fluid, such as a liquid, for example syrup. In a third container section 5 of the container 2, a finished mixture of the first starting fluid, the second starting fluid and an impregnation medium is contained, the impregnation medium being optional.

The three container sections 3, 4 and 5 are separated from each other in a fluid-tight manner. Here, the first container section 3 is separated from the second container section 4 by a first partition 6. The second container section 4 is separated from the third container section 5 by a second partition 7. The three container sections 3, 4 and 5 are present within the same container 2, thus they have a common outer wall 8.

From the first container section 3, a first conduit 9 leads to a first pump 10 and then to a mixing area 11. From the second container section 4, a second conduit 12 leads to a second pump 13 and then further to the mixing area 11. It is possible that just before the mixing area 11, both in the first conduit 9 and in the second conduit 12, one control valve 14 each is installed. Between the mixing area 11 and the first pump 10 or the second pump 13, respectively, a flow indicator 15 is moreover installed. Between this flow indicator 15 and the control valves 14, check valves 16 are present.

The first pump 10 and the second pump 13 are each connected with a separate synchronous motor which is not represented. Each of the two synchronous motors is connected to a separate frequency converter, the frequency converter also not represented.

The two starting fluids, that means the first starting fluid and the second starting fluid, are mixed in the mixing area 11 and subsequently brought to a cooler 18 in a common conduit 17. Then, via the common conduit 17, the cooled mixture is brought to another pump 19, which is referred to as mixture pump or carbonization pump. This pump 19 is also connected to a separate synchronous motor which is in turn controlled by a separate frequency converter.

The mixture quantity delivered by the pump 19 then penetrates an injector 20. The injector 20 is designed as a venturi tube. A bypass conduit 21 connects an outlet of the injector 20 with the mixing area 11. The outlet of the injector 20, however, is also connected with the third container section 5 of the container 2 via a conduit 22 and/or a conduit 23. A pressure pickup can also be located in the conduit 22 which is connected with a shutoff or throttle valve 25 in the same conduit 22.

Via another pump 26 in a conduit 27 leading out of the third container section 5, the finished mixture can be supplied to a filler 28.

The common conduit 17 and the bypass conduit 21 are connected in such a manner that a clockwise circuit can be formed as symbolized by the arrow A. However, it is also possible to select the feeding of the circuit such that a direction opposite to the arrow direction A is obtained, whereby the injector 20 is after all bypassed.

The individual pumps 10, 13, 19 and 26 are designed as centrifugal pumps and comprise allocated synchronous motors which are controlled by separate frequency converters. So, the synchronous motors can be controlled independent of each other.

As a frequency converter, one of the Danfoss FC302 type turned out to be suited as it cannot only control asynchronous motors but also synchronous motors.

1. A mixer for mixing and conveying different fluids for a beverage filling plant, comprising at least one first container section for receiving a first starting fluid, comprising a second container section for receiving a second starting fluid, a first pump disposed in a first conduit leading out of the first container section for supplying the first starting fluid to a mixing area, a second pump disposed in a second conduit leading out of the second container section for supplying the second starting fluid to the mixing area, the first pump and the second pump being driven by one synchronous motor each and each synchronous motor is connected to a frequency converter for flow control, wherein the first and the second container sections are embodied in one common container.

2. The mixer according to claim 1, wherein each of the first and the second pumps is a centrifugal pump.

3. The mixer according to claim 1, wherein, in that in the mixing area, downstream of an opening area of the second conduit into the first conduit, a cooler is arranged, and further wherein a mixture pump for conveying the cooled mixture of the first and the second starting fluid to an injector is arranged downstream of the first and the second pumps.

4. The mixer according to claim 3, and wherein an injector outlet area of the injector is connected to a third container section of the container to intermediately store the fluid prepared for filling at the beverage filling plant.

5. The mixer according to claim 3, wherein the injector is designed for supplying an impregnation medium.

6. The mixer according to claim 5, wherein the first starting fluid is a liquid, the second starting fluid is a liquid, and the impregnation medium is one of CO₂, O₂, nitrogen, and nitrous oxide.

7. The mixer according to claim 3, and wherein a bypass conduit disposed downstream of the injector ensures a circuit from the opening area one of via the cooler, the mixture pump driven by a synchronous motor, and the injector to the opening area, and via the reverse thereof.

8. The mixer according to claim 4, and wherein a product pump driven by a synchronous motor is disposed downstream of the third container section.

9. The mixer (1) according to claim 1, wherein no separate throttle is installed in a mixture area of the mixer.

10. The mixer (1) according to claim 1, wherein one of a motor with a direct drive and a gearless motor, is employed as a synchronous motor for one of the pumps.

11. A beverage filling plant comprising a mixer according to claim 1.

12. A method of operating a beverage filling plant having a mixer according to claim 1, comprising controlling the frequency converter of the respective synchronous motor of one of the first pump, the second pump, the mixture pump, the product pump, and a combination thereof, such that flow control is achieved by modulation of the respective pump.

13. The method according to claim 12, wherein a flow rate of mixed liquid is kept constant at the injector, while a working speed of the individual components is kept variable.

14. The mixer according to claim 5, wherein the impregnation medium is a gas.

15. The mixer according to claim 6, wherein he first starting fluid is water.

16. the mixer according to claim 6, wherein the second starting fluid is syrup.

17. The mixer according to claim 10, wherein the gearless motor is a torque motor.
